(19) United States
(12) Patent Application Publication
(10) Pub. No.: US 2014/0166888 A1
(43) Pub. Date: Jun. 19, 2014

(54) SENSING APPARATUS AND THE PIXEL STRUCTURE THEREOF

(71) Applicant: Industrial Technology Research Institute, Hsinchu (TW)

(72) Inventors: Hui-Hsin Lu, New Taipei City (TW); Tsung-Ter Kuo, Taichung City (TW); Ting-Hsuan Chen, Taoyuan County (TW)

(21) Appl. No.: 13/845,137

(22) Filed: Mar. 18, 2013

(30) Foreign Application Priority Data
Dec. 13, 2012 (TW) 101147279

(51) Int. Cl. G01T 1/20

(52) U.S. Cl. CPC G01T 1/20
USPC 250/366; 250/394

(57) ABSTRACT

A pixel structure includes a first photoelectric conversion layer, a second photoelectric conversion layer, a blocking layer, a first electronic element layer and a second electronic element layer. The first photoelectric conversion layer converts a first energy portion of an X-ray into a first electrical signal and the second photoelectric conversion converts a second energy portion thereof into a second electrical signal. The blocking layer is disposed between the first and second photoelectric conversion layers to filter out partial ray with a portion of the frequency range of the X-ray. The first electronic element layer is disposed between the first photoelectric conversion layer and the blocking layer to enable the first photoelectric conversion layer and receive the first electrical signal; the second electronic element layer is disposed between the second photoelectric conversion layer and the blocking layer to enable the second photoelectric conversion layer and receive the second electrical signal.

### CROSS-REFERENCE TO RELATED APPLICATION

This application claims the priority benefit of Taiwan application serial no. 101147279, filed on Dec. 13, 2012. The entirety of the above-mentioned patent application is hereby incorporated by reference herein and made a part of this specification.

### TECHNICAL FIELD

The technical field generally relates to a sensing apparatus and the pixel structure thereof.

### BACKGROUND

X-ray (i.e., X-light) medical imaging is a non-invasive method for checking the structure inside a human body and it can be quickly aware of the anatomy information of a subject (such as shape structures of bones, organs and soft tissues) without performing anatomy practice or tissue sectioning. Therefore, X-ray medical imaging result has served as one of the bases of medical diagnosis. The conventional X-ray imaging technology uses X-ray with higher-frequency energy range, which has excellent distinguishable capability to recognize bones from soft tissue so as to be often used for bone radiography. However, because the composition differences of soft tissues at various parts of the body are not significant, the image differences within the X-ray energy range of bone radiography caused by the composition differences between the soft tissues are not significant as well. As a result, the soft tissue imaging result is not easily distinguished and is difficult to serve for medical diagnosis on soft tissues.

In recent years however, along with digitizing the X-ray images, the soft tissue radiography through the X-ray becomes feasible already. It should be noted that the attenuations of X-ray with different energy ranges after penetrating through bones and soft tissue are different. Based on the principle, a dual-energy X-ray system with two different energy ranges are used to respectively take photograph on a body position and obtain the X-ray images, followed by a signal processing, the images for the soft issue and the hard issue (or the images of contrast agent or implant) can be distinguished from each other. By using the X-ray with different energy ranges, the attenuation difference on the bone is significant, but it is not significant on the soft tissue. After performing the successive image processing of the dual-energy X-ray system, the recognisability for soft tissues in the image can be advanced, which facilitates to aid medical diagnosis.

In general, the current clinical dual-energy X-ray system includes a digital radiography (DR) technology system and a computer-aided radiography (CR) system, in which the DR systems uses two X-ray light sources with different energy ranges to expose a subject twice and to respectively obtain two images, serving for a subsequent image processing; the CR system uses a single X-ray light source with a wide energy range and uses a filter on the X-ray sensor thereof to obtain two images with different energies for a subsequent image processing. However, when the DR system takes photograph for every time, the X-ray needs to expose the subject twice or over, which not only affects the health of the subject, but also may result in image differences due to the subject moving during the twice subsequent shootings and the image differences may affect the successive image processing to produce ghost shadow or blur and further affect the medical diagnosis. In addition, the shot image obtained by the CR system needs to be scanned by laser to convert the image content (latent image) into a digital image, and the operation time of each image consumes several minutes up to tens of minutes. Therefore, the CR method is not suitable for real-time X-ray image detection and is hard to be used in the timely monitoring of clinical surgery. In short, how to reduce the radiation exposure dose of subjects and advance image sharpness to be adapted to the rapid X-ray image detection is one of the problems to be solved today.

### SUMMARY

An embodiment of the disclosure provides a pixel structure of sensing apparatus, which includes a first scan line, a second scan line, a reading line, a first sensing unit and a second sensing unit. The first sensing unit is coupled between the first scan line and a bias and is coupled between the reading line and the bias. The first sensing unit is for sensing a first energy of the X-ray with a first frequency range, and the first sensing unit outputs a first reading signal corresponding to the first energy to the reading line in response to a first scan signal on the first scan line. The second sensing unit is coupled between the second scan line and the bias and between the reading line and the bias. The second sensing unit is for sensing a second energy of the X-ray with a second frequency range, and the second sensing unit outputs a second reading signal corresponding to the second energy to the reading line in response to a second scan signal on the second scan line, in which the first scan signal and the second scan signal respectively enable the first sensing unit and the second sensing unit.

An embodiment of the disclosure provides a sensing apparatus, which includes a first photoelectric conversion layer, a second photoelectric conversion layer, a blocking layer, a first electronic element layer and a second electronic element layer. The first photoelectric conversion layer is used for converting a first energy portion of an X-ray into a first electrical signal. The second photoelectric conversion layer is used for converting a second energy portion of the X-ray into a second electrical signal. The blocking layer is disposed between the first photoelectric conversion layer and the second photoelectric conversion layer to filter out partial ray with a portion of the frequency range of the X-ray from the X-ray. The first electronic element layer is disposed between the first photoelectric conversion layer and the blocking layer to enable the first photoelectric conversion layer and receive the first electrical signal; the second electronic element layer is disposed between the second photoelectric conversion layer and the blocking layer to enable the second photoelectric conversion layer and receive the second electrical signal.

An embodiment of the disclosure provides a sensing apparatus, which includes a plurality of pixel structures and an electronic element layer. Each of the pixel structures includes at least one first pixel unit and at least one second pixel unit, the first pixel unit is for sensing the X-ray with a first frequency range and the second pixel unit is for sensing the X-ray with a second frequency range. The first pixel unit and the second pixel unit of the pixel structures herein are alternately arranged in two dimensions. In addition, the first sensing unit and the second sensing unit are coupled to the electronic element layer. The electronic element layer receives a first electrical signal produced by the first sensing unit in every pixel structure corresponding to the X-ray with the first frequency range and receives a second electrical signal produced by the second sensing unit corresponding to the X-ray with the second frequency range.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an equivalent circuit diagram of a pixel structure of sensing apparatus according to an embodiment of the disclosure.

FIG. 2 is a waveform diagram of the sensing apparatus in FIG. 1.

FIG. 3 is a cross-sectional diagram of the sensing apparatus in the embodiment of FIG. 1.

FIG. 4 is a cross-sectional diagram of a sensing apparatus according to another embodiment of the disclosure.

FIG. 5A is a schematic diagram of a sensing according to yet another embodiment of the disclosure.

FIG. 5B is a partial top-view diagram of the sensing apparatus in the embodiment of FIG. 5A.

FIG. 6A is a diagram of the pixel apparatus in the embodiment of FIG. 5A after a first modification.

FIG. 6B is a partial top-view diagram of the pixel apparatus in the embodiment of FIG. 6A.

FIG. 6C is a diagram of the pixel apparatus in the embodiment of FIG. 5A after a second modification.

FIG. 6D is a partial top-view diagram of the pixel apparatus in the embodiment of FIG. 6C.

FIG. 7 is a diagram of the pixel apparatus in the embodiment of FIG. 5A after a third modification.

FIG. 8 is a diagram of the pixel apparatus in the embodiment of FIG. 5A after a fourth modification.

FIG. 9 is a diagram of the pixel apparatus in the embodiment of FIG. 5A after a fifth modification.

FIG. 10 is a diagram of the pixel apparatus in the embodiment of FIG. 5A after a sixth modification.

### DETAILED DESCRIPTION OF DISCLOSED EMBODIMENTS

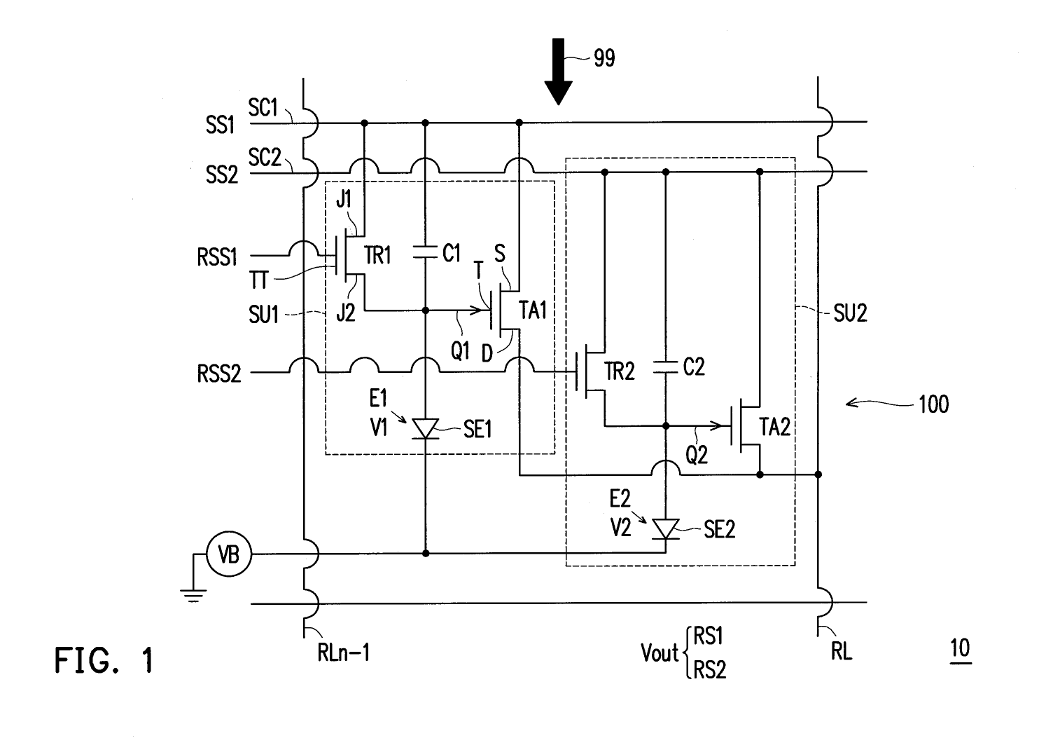

FIG. 1 is an equivalent circuit diagram of a pixel structure of sensing apparatus according to an embodiment of the disclosure. Referring to FIG. 1, in the embodiment, the pixel structure 100 includes a first scan line SC1, a second scan line SC2, a reading line RL, a first sensing unit SU1 and a second sensing unit SU2. The first sensing unit SU1 is coupled between the first scan line SC1 and a bias VB and between the reading line RL and the bias VB. The first sensing unit SU1 is used for sensing a first energy E1 of the X-ray 99 with a first frequency range V1, and the first sensing unit SU1 outputs a first reading signal RS1 corresponding to the first energy E1 to the reading line RL in response to a first scan signal SS1 on the first scan line SC1. The second sensing unit SU2 is coupled between the second scan line SC2 and the bias VB and between the reading line RL and the bias VB. The second sensing unit SU2 is used for sensing a second energy E2 of the X-ray 99 with a second frequency range V2, and the second sensing unit SU2 outputs a second reading signal RS2 corresponding to a second energy E2 to the reading line RL in response to a second scan signal SS2 on the second scan line SC2, in which the first scan signal SS1 and the second scan signal SS2 respectively enable the first sensing unit SU1 and the second sensing unit SU2. In the embodiment, FIG. 1 gives an equivalent circuit diagram of a single pixel structure 100, in which the n-th pixel serves as an example. The sensing apparatus 10 in the embodiment can include a plurality of pixel structures 100, while in other pixel structures 100, different subscripts are used for notation (e.g., which is omitted to describe. In other words, in the embodiment, each of the pixel structures 100 can sense the first energy E1 of the first frequency range V1 and the second energy E2 of the second frequency range V2 in a single exposure by applying a same bias VB to the first sensing unit SU1 and a second sensing unit SU2. Then, the above-mentioned pixel structure 100 sequentially reads the first reading signal RS1 corresponding to the first energy E1 and the second reading signal RS2 corresponding to the second energy E2 through the same reading line RL. The first reading signal RS1 is the output of the first sensing unit SU1 and can be reset by a successive resetting signal to clear residual carrier of the last pixel (i.e., the residual electrical noise signal after reading the pixel). In this way, two images can be obtained by irradiations of the X-ray with two different frequency ranges in a single exposure, which can avoid a subject from accepting higher radiation dose due to multiple repeating exposures and further enhance the image quality of the X-ray image through the successive signal and image processing, for example, by superposing or matching the human body images obtained respectively by the irradiation of the X-ray with a higher frequency range and by the irradiation of the X-ray with a lower frequency range so as to separate bone images from soft issue images. The above-mentioned scheme can also facilitate to aid clinical pathological diagnosis and can be applied to other medical tests such as pleural detection (can be used to eliminate the influence of the ribs so as to more clearly observe the lungs), dental (to eliminate the influence of teeth and jaws so as to more clearly observe the oral soft tissue), breast detection (to more clearly observe the breast blood vessels, glands and lumps), bone mineral density, angiography, implantable medical material and medical material related to medical cosmetology, etc. The sensing apparatus 10 in the embodiment can be applied to other non-biological materials, which the disclosure is not limited to.

In more details, continuing to FIG. 1, in the embodiment, the first sensing unit SU1 can include a first sensing element SE1, a first storage element C1, a first amplifying element TA1 and a first resetting element TR1. The first sensing element SE1 can be used to sense the first energy E1 and convert the sensed first energy E1 into a first electrical signal Q1. The first storage element C1 is coupled to the first scan line SC1 and the first sensing element SE1 and for storing the first electrical signal Q1. The first amplifying element TA1 is coupled to the first storage element C1, the first scan line SC1 and the reading line RL, in which the first amplifying element TAloutputs the first reading signal RS1 corresponding to the first electrical signal Q1 to the reading line RL in response to the first scan signal SS1 come from the first scan line SC1. The first resetting element TR1 is coupled to the first storage element C1 and the first scan line SC1, in which the first resetting element TR1 is used to reset the first storage element C1 in response to a first resetting signal RSS1. When the X-ray 99 irradiates the materials of the first sensing element SE1 and the second sensing element SE2, the materials can absorb the energy of the X-ray 99 to produce electron-hole pairs. In more details, the material of the first sensing element SE1 includes amorphous selenium (a-Se), lead oxide (PbO), mercury (II) iodide (HgI₂) or a combination thereof. The first amplifying element TA1 and the first resetting element TR1 are, for example, transistors, and the first storage element C1 is, for example, capacitor, which the disclosure is not limited to.

In more details, a current input terminal S of the first amplifying element TA1 is coupled to the first scan line SC1 and a terminal of the first storage element C1, a control terminal T of the first amplifying element TA1 is coupled to the other terminal of the first storage element C1, and a current output terminal D of the first amplifying element TA1 is coupled to the reading line RL. For example, in the embodiment, if the first scan signal SS1 is in high level, the control terminal T of the first amplifying element TA1 after getting capacitance coupling by the first storage element C1 (for example, a capacitor) is in high level as well so as to make the current input terminal S and the current output terminal D conducted therebetween, and the current output terminal D is able to output the first reading signal RS1 to the reading line RL corresponding to the first electrical signal Q1. In this way, a first energy E1 of the X-ray 99 with the first frequency range V1 can be calculated from the first reading signal RS1 to facilitate the successive image processing.

A first terminal J1 of the first resetting element TR1 is coupled to the first scan line SC1, a control terminal TT of the first resetting element TR1 receives the first resetting signal RSS1, and a second terminal J2 of the first resetting element TR1 is coupled to the control terminal T of the first amplifying element TA1. For example, in the embodiment, if the first resetting element TR1 received by the control terminal TT of the first resetting element TR1 is in high level, the first terminal J1 and the second terminal J2 of the first resetting element TR1 can be conducted therebetween. At the time, no bias VB is provided and the first scan signal SS1 of the first scan line SC1 is in low level, which makes the control terminal T of the first amplifying element TA1 in low level as well, the current input terminal S and the current output terminal D of the first amplifying element TA1 are in break circuit therebetween, and finally, the output of the first reading signal RS1 is terminated until the next input of the first scan signal SS1.

In addition, the second sensing element SE2, the second amplifying element TA2, the second resetting element TR2 and the second storage element C2 in the second sensing unit SU2 are in operation similar to the operation in the first sensing unit SU1 so as to sense the second energy E2 of the X-ray 99 in the second frequency range V2 and output the second reading signal RS2 corresponding to the second electrical signal Q2 to the reading line RL, which is omitted to describe.

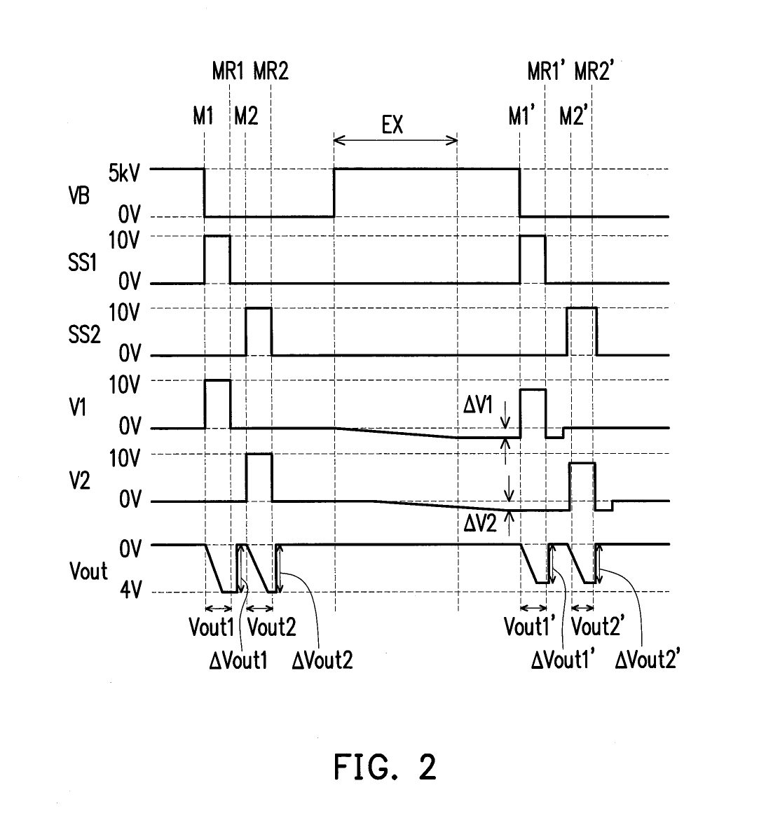

FIG. 2 is a waveform diagram of the sensing apparatus in FIG. 1. Referring to FIGS. 1 and 2, in the embodiment, the waveform diagram of FIG. 2 shows up the waveforms of all signals during sensing the X-ray 99 by the sensing apparatus 10. First, prior to accepting the irradiation of the X-ray 99, the first scan signal SS1 (such as time point M1 in FIG. 2) and the second scan signal SS2 (such as time point M2 in FIG. 2) are respectively input. At the time, the bias VB is closed. Then, the reading line RL receives a voltage signal Vout1 (received at the time points M1-MR1) and a voltage signal Vout2 (received at the time points M2-MR2) respectively related to the first scan signal SS1 and the second scan signal SS2. When the X-ray 99 is irradiating the first sensing element SE1 and the second sensing element SE2 in an exposing duration EX (for example, taking an X-ray 99 image), the bias VB (for example, 5 kV herein) is provided to the first sensing element SE1 and the second sensing element SE2. At the time, the first sensing element SE1 irradiated by the X-ray 99 produces a photocurrent in response to the first energy E1 of the first frequency range V1 in the X-ray 99, which further makes the bias VB apply a positive voltage at a side of the first storage element C1 far away from the first scan line SC1. In other words, when the first sensing element SE1 is exposed by the first frequency range V1 of the X-ray 99, the first sensing element SE1 makes discharge to the control terminal T corresponding to the intensity of the X-ray 99. At the time, the voltage of the first electrical signal Q1 is declined with the irradiation duration and the intensity of the X-ray 99. Once the sensing (i.e., exposing) is finished, during reading the first electrical signal Q1 sensed by the first sensing element SE1 corresponding to the intensity of the first energy E1, the first scan signal SS1 is in high level (for example, the time point M1′ in FIG. 2) and the bias VB is switched to zero, and meanwhile, the first scan signal SS1 and the first electrical signal Q1 are in high level (for example, 10V in the figure). Thereafter, the voltage change ΔVout1′ of the voltage signal Vout1′ of the first reading signal RS1 read from the reading line RL at the time point MR1′ is less than the voltage change ΔVout1 of the voltage signal Vout1. Based on the above-mentioned situation, the intensity of the first energy E1 of the X-ray 99 can be calculated according to the difference between the voltage change ΔVout1 and the voltage change ΔVout1′.

After reading the voltage signal Vout1′ of the first reading signal RS1, the first resetting element RSS1 is switched to high level to reset the first storage element C1 and the bias VB is closed at the time, which further makes the first electrical signal Q1 back to low level, and then, the bias VB is re-provided until the next exposing. It should be noted that the second sensing unit SU2 can, similar to the operation of the first sensing unit SU1, switch the second reading signal RS2 (at the time point M2′) to high voltage (for example, 10V in the FIG. 2), read the second reading signal RS2 at the time point MR2′ and calculate out the voltage change ΔVout2′. The intensity of the second energy E2 of the X-ray 99 can be calculated according to the difference between the voltage change ΔVout2 of the voltage signal Vout2 and the voltage change ΔVout2′ of the voltage signal Vout2′, and the second electrical signal Q2 can be similarly switched to low voltage (as the low voltage in FIG. 2), which is omitted to describe.

Taking FIG. 2 as an example, the voltage decrease ΔV1 of the first electrical signal Q1 during exposing the first sensing element SE1 is about 1V and the voltage decrease ΔV2 of the second electrical signal Q2 during exposing the second sensing element SE2 is about 1V, which the disclosure is not limited to. In the embodiment, the circuit related to the first sensing unit SU1 and the second sensing unit SU2 is disposed, for example, at a thin film transistor layer (TFT layer) or complementary metal-oxide-semiconductor-like (CMOS-like) layer, the first amplifying element TA1, the first resetting element TR1, the second amplifying element TA2 and the second resetting element TR2 can be transistor or CMOS-like elements, the current input terminal S and the first terminal J1 can be drain of transistor or CMOS-like elements, the current output terminal D and the second terminal J2 can be source of transistor or CMOS-like elements, and the control terminal T and the control terminal TT can be gate of transistor or CMOS-like elements, which the disclosure is not limited to.

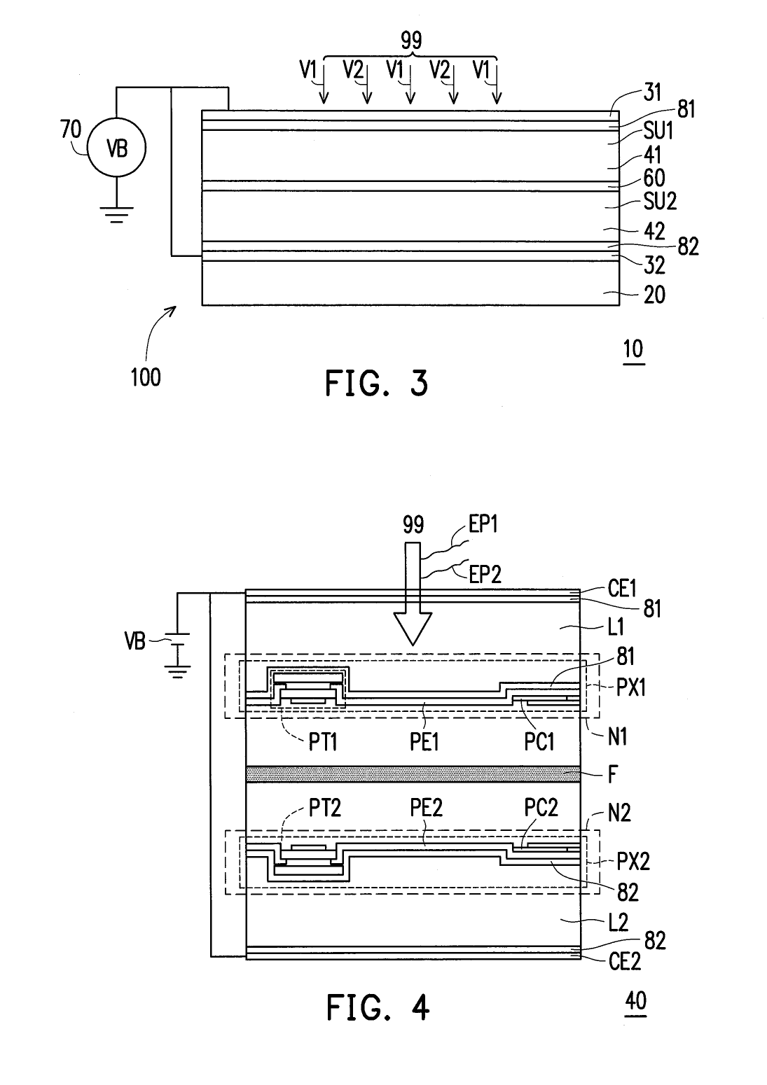

FIG. 3 is a cross-sectional diagram of the sensing apparatus in the embodiment of FIG. 1. Referring to FIGS. 1 and 3, in the embodiment, the pixel structure 100 of FIG. 1 can be a stacking structure, as shown by FIG. 3. The first sensing layer 41 and the second sensing layer 42 are disposed between the first common electrode layer 31 and the second common electrode layer 32, in which the first sensing unit SU1 can be disposed at the first sensing layer 41 and the second sensing unit SU2 can be disposed at the second sensing layer 42. In more details, the first sensing element SE1, the first storage element C1, the first amplifying element TA1 and the first resetting element TR1 can be disposed at the first sensing layer 41, and the second sensing element SE2, the second storage element C2, the second amplifying element TA2 and the second resetting element TR2 can be disposed in the second sensing layer 42 so as to achieve the same effect in FIGS. 1 and 2, the first common electrode layer 31, the first sensing layer 41, the second sensing layer 42 and the second common electrode layer 32 herein are sequentially stacked on a substrate 20, in which the first common electrode layer 31 and the second common electrode layer 32 are connected to a voltage source 70, and the voltage source 70 provides the bias VB to the first common electrode layer 31 and the second common electrode layer 32. In addition, a high bias (in the embodiment, for example, a bias over 5 kV, depending on the thickness of the photosensitive material) is applied to the pixel structure 100 through the first common electrode layer 31 and the second common electrode layer 32. In comparison with the architecture where each pixel structure has an independent electrode disposed, the first common electrode layer 31 and the second common electrode layer 32 are easier to be fabricated, which can simplify the process and advance the production yield. The pixel structure 100 can further include a blocking layer 60 disposed between the first sensing unit SU1 and the second sensing unit SU2 (i.e., between the first sensing layer 41 and the second sensing layer 42). The blocking layer 60 masks a portion of the X-ray 99 for the frequency falling in the first frequency range V1 but out of the second frequency range V2, and the other portion of the X-ray 99 with the second frequency range V2 penetrates through the blocking layer 60, in which the X-ray 99 sequentially passes through the first sensing unit SU1, the blocking layer 60 and the second sensing unit SU2. It should be noted that the first frequency range V1 and the second frequency range V2 in the embodiment are substantially not overlapped with each other. However in other embodiments, the first frequency range V1 and the second frequency range V2 are substantially and partially overlapped with each other, which the disclosure is not limited to. Thus, during a single exposing, the blocking layer 60 is able to filter out a portion of the frequency range of the X-ray 99 to respectively detect the first energy E1 of the first frequency range V1 and the second energy E2 of the second frequency range V2. At the time, the first energy E1 and the second energy E2 can be quickly calculated out as the reading way shown in FIG. 2. In this way, the pixel structure 100 can quickly obtain the images shot through the X-ray 99 with two frequency ranges by a single exposure, which can reduce the received radiation doses of the subject, meanwhile can also reduce ghost shadow or blur due to the moving or breathing of the subject during multi-shots and can quickly read the images shot through the X-ray 99 with two frequency ranges so as to facilitate to aid clinical medical diagnosis.

In addition, in the embodiment, the pixel structure 100 can further include a first diffusion blocking layer 81 and a second diffusion blocking layer 82. The first diffusion blocking layer 81 is disposed between the first common electrode layer 31 and the first sensing layer 41, and the second diffusion blocking layer 82 is disposed between the second common electrode layer 32 and the second sensing layer 42. The materials of the first diffusion blocking layer 81 and the second diffusion blocking layer 82 are, for example, conductive polymer or oxide semiconductor with thickness ranging from 100 nm to 100 mm, or a mixture of zinc oxide (ZnO), tin oxide (SnO₂) or cadmium selenide (CdSe) and gallium (Ga), indium (In), tin (Sn) or hafnium (Hf) with thickness ranging from 100 nm to 100 mm, which the disclosure is not limited to. The first diffusion blocking layer 81 and the second diffusion blocking layer 82 are used to prevent charges from pouring to the first sensing layer 41 and the second sensing layer 42 at high bias to produce dark current, which can advance the quality of the sensed signal.

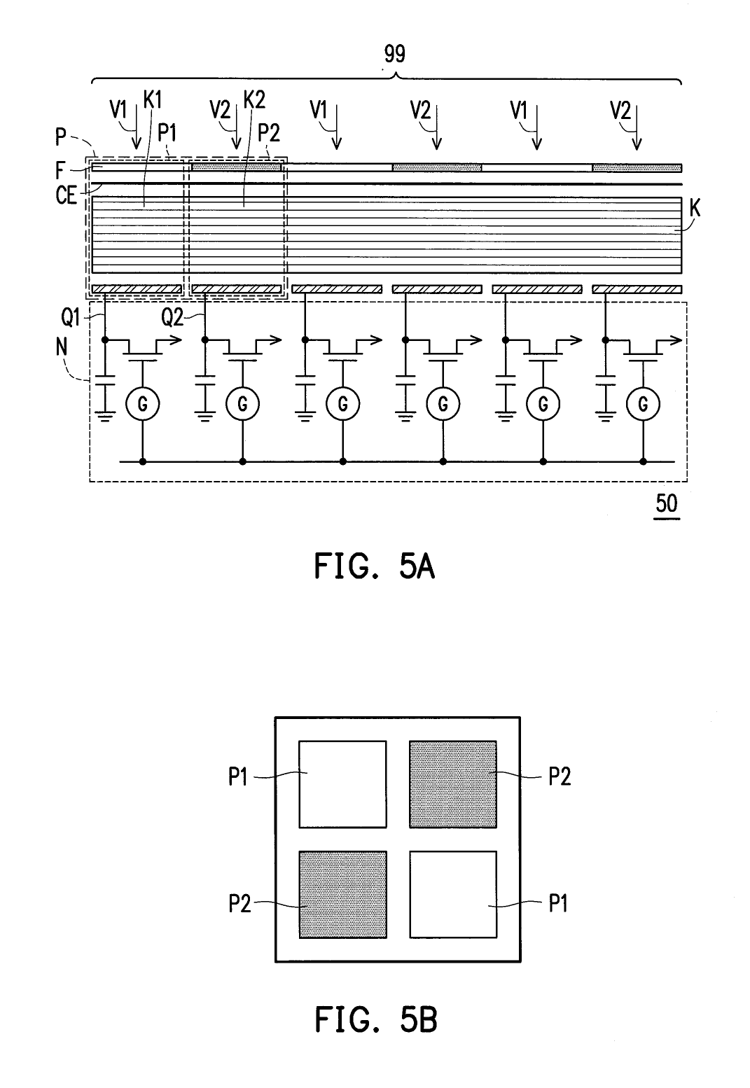

FIG. 4 is a cross-sectional diagram of a sensing apparatus according to another embodiment of the disclosure. Referring to FIG. 4, similarly to FIGS. 1 and 3, in the embodiment, the sensing apparatus 40 includes a first photoelectric conversion layer L1, a second photoelectric conversion layer L2, a blocking layer F, a first electronic element layer N1 and a second electronic element layer N2. The first photoelectric conversion layer L1 is used to convert a first energy portion EP1 of an X-ray 99 into a first electrical signal Q1, and the second photoelectric conversion layer L2 is used to convert a second energy portion EP2 of the X-ray 99 into a second electrical signal Q2. The blocking layer F is disposed between the first photoelectric conversion layer L1 and the second photoelectric conversion layer L2 to filter out partial ray of the X-ray 99 with a portion of the frequency range. For example, in the embodiment, the blocking layer F can mask a portion of the X-ray 99 for the frequency falling in the first frequency range V1 but out of the second frequency range V2, and the other portion of the X-ray 99 with the second frequency range V2 can penetrate through the blocking layer F, similarly to the blocking layer 60 in FIG. 3. In the embodiment, the frequency range of the first energy portion EP1 and the frequency range of the second energy portion EP2 are substantially not overlapped with each other or partially overlapped with each other. The frequency range to be masked is determined by the material of the blocking layer F, in which the blocking layer F can be aluminium (Al), copper (Cu), tin (Sn), lead (Pb), zinc (Zn), samarium (Sm), cerium (Ce), gadolinium (Gd), erbium (Er), rhodium (Rh), a compound or a mixture, in which the absorbing frequency range of each material kind on the X-ray 99 is given in following

TABLE 1
Table 1

| Frequency Range | Material |
|---|---|
| 30k-120 kV | aluminium (Al¹³) |
| 100k-250 kV | copper (Cu²⁹) |
| 200k-00 kV | tin (Sn⁵⁰) |
| 600k-2 MV | lead (Pb⁸²) |

In other embodiments, the penetrating frequency range can be determined by selecting different masking materials so as to receive the X-ray with different frequency ranges by different layers in a single exposure. In the embodiment, when the X-ray irradiates the materials of the first photoelectric conversion layer L1 and the second photoelectric conversion layer L2, the material can absorb the energy of the X-ray to produce electron-hole pairs. In more details, the materials of the first photoelectric conversion layer L1 and the second photoelectric conversion layer L2 include amorphous selenium (a-Se), lead oxide (PbO), mercury iodide (HgI₂) or a combination thereof. The received wavelengths of the first photoelectric conversion layer L1 and the second photoelectric conversion layer L2 can be determined by selecting different materials.

Continuing to FIG. 4, in the embodiment, the first electronic element layer N1 is disposed between the first photoelectric conversion layer L1 and the blocking layer F to enable the first photoelectric conversion layer L1 and receive the first electrical signal Q1; the second electronic element layer N2 is disposed between the second photoelectric conversion layer L2 and the blocking layer F to enable the second photoelectric conversion layer L2 and receive the second electrical signal Q2. In the embodiment, the first electronic element layer N1 and the second electronic element layer N2 include, for example, TFT layer, which can make the X-ray 99 penetrate through and respectively received by the first photoelectric conversion layer L1 and the second photoelectric conversion layer L2, which the disclosure is not limited to. Moreover, the first electronic element layer N1 has a plurality of first pixel units PX1, and the first pixel units PX1 include at least a first transistor PT1, a first pixel electrode PE1 and a first storage capacitor PC1 coupled to each other; the second electronic element layer N2 has a plurality of second pixel units PX2, and second pixel units PX2 include at least a second transistor PT2, a second pixel electrode PE2 and a second storage capacitor PC2 coupled to each other. More specifically, in the present embodiment, each of the first pixel units PX1 includes at least a first transistor PT1, a first pixel electrode PE1 and a first storage capacitor PC1 coupled to each other, and each of the second pixel units PX2 includes at least a second transistor PT2, a second pixel electrode PE2 and a second storage capacitor PC2 coupled to each other. In the embodiment, the sensing apparatus 40 further includes a first common electrode layer CE1 and a second common electrode layer CE2. The first common electrode layer CE1 is disposed on the first photoelectric conversion layer L1, i.e., the first photoelectric conversion layer L1 is disposed between the first electronic element layer N1 and the first common electrode layer CE1; the second common electrode layer CE2 is disposed on the second photoelectric conversion layer L2, i.e., the second photoelectric conversion layer L2 is disposed between the second electronic element layer N2 and the second common electrode layer CE2 and both the first common electrode layer CE1 and second common electrode layer CE2 are coupled to the same bias VB. The first common electrode layer CE1 and the second common electrode layer CE2 herein can include, for example, indium tin oxide (ITO) film or tin oxide (SnO₂) and any conductive metals, conductive metal oxides or conductive polymers, etc., which the disclosure is not limited to. In the embodiment, as shown by FIG. 4, the X-ray 99 sequentially passes through the first common electrode layer CE1, the first photoelectric conversion layer L1 and the first electronic element layer N1, in which the first energy portion EP1 of the X-ray 99 is absorbed by the first photoelectric conversion layer L1 and is converted into the first electrical signal Q1. Then, the first electrical signal Q1 is transmitted to the first transistor PT1 by the first pixel electrode PE1 in the first electronic element layer N1 to be stored in the first storage capacitor PCI for reading later. On the other hand, after the X-ray 99 sequentially passes through the first common electrode layer CE1, the first photoelectric conversion layer L1 and the first electronic element layer N1, the blocking layer F blocks the first energy portion EP1 but allows the second energy portion EP2 to be penetrated, followed by sequentially passing through the second electronic element layer N2, the second photoelectric conversion layer L2 and the second common electrode layer CE2. The second energy portion EP2 of the penetrating X-ray 99 is absorbed by the second photoelectric conversion layer L2 to be converted into the second electrical signal Q2, and then, the second electrical signal Q2 is transmitted to the second transistor PT2 by the second pixel electrode PE2 in the second electronic element layer N2 to be stored in the second storage capacitor PC2 for reading later. In the embodiment, first common electrode layer CE1, the first photoelectric conversion layer L1 and the first electronic element layer N1 as well as the second electronic element layer N2, the second photoelectric conversion layer L2 and the second common electrode layer CE2 respectively have a reverse arrangement sequence from each other (i.e., they are symmetrically disposed about the blocking layer F as a symmetrical axis). In other words, the first common electrode layer CE1 and the second common electrode layer CE2 enclose the first photoelectric conversion layer L1, the first electronic element layer N1, the second electronic element layer N2 and the second photoelectric conversion layer L2, which facilitates the fabrications of the first common electrode layer CE1 and the second common electrode layer CE2 and bias and can protect the first photoelectric conversion layer L1, the first electronic element layer N1, the second electronic element layer N2 and the second photoelectric conversion layer L2, which the disclosure is not limited to. In other embodiments, there are other stacking arrangement sequences to adapt to different processes and designs. In the above-mentioned design, each pixel of the sensing apparatus 40 can simultaneously obtain the first electrical signal Q1 of the first energy portion EP1 and the second electrical signal Q2 of the second energy portion EP2 in the X-ray 99 during a single exposing and they are stored in the first storage capacitor PC1 and the second storage capacitor PC2 for reading later. In other words, the image of the subject can be obtained by a single shooting by using an X-ray with two different frequency ranges, which can reduce the received radiation dose during shooting and it can quickly respectively read the first electrical signal Q1 and the second electrical signal Q2 sensed by every pixel in the sensing apparatus 40 for the successive image processing, such as to strengthen the image display of the bones or to eliminate the bone from the X-ray images to more clearly observe soft tissue. All these can be applicable to other medical detections such as pleural detection (to eliminate the impact of ribs so as to more clearly observe the lungs), dental detection (to eliminate the impact of the teeth and jaw bone so as to more clearly observe oral soft tissue), bone mineral density, breast detection (to more clearly observe breast blood vessels, glands and lumps) and angiography. The pixel structure 100 can be also applicable to other non-biological materials, which the disclosure is not limited to. In addition, in the embodiment, the sensing apparatus 40 can, as described in the embodiment of FIG. 3, include a first diffusion blocking layer 81 and a second diffusion blocking layer 82. The first diffusion blocking layer 81 is disposed between the first common electrode layer CE1 and the first photoelectric conversion layer L1 and between the first photoelectric conversion layer L1 and the first electronic element layer N1, and the second diffusion blocking layer 82 is disposed between the second common electrode layer CE2 and the second photoelectric conversion layer L2 and between the second photoelectric conversion layer L2 and the second electronic element layer N2, in which the materials and the functions of the first diffusion blocking layer 81 and the second diffusion blocking layer 82 can refer to the embodiment of FIG. 3, which is omitted to describe.

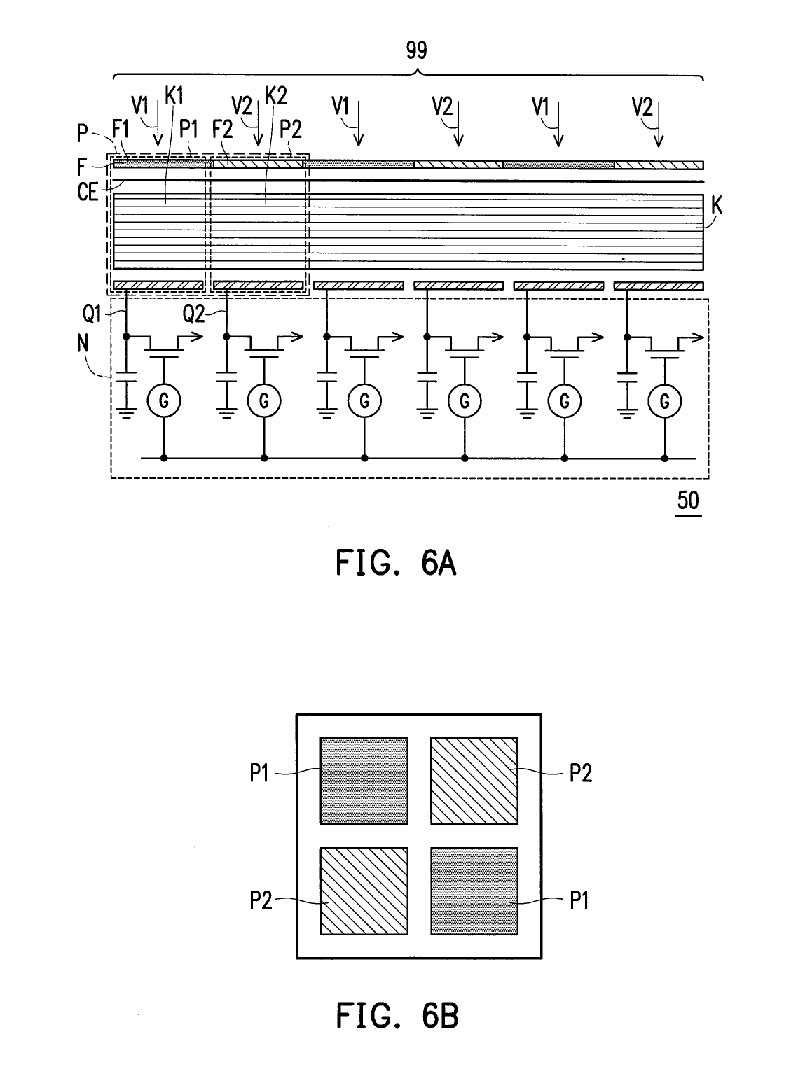

FIG. 5A is a schematic diagram of a sensing according to yet another embodiment of the disclosure and FIG. 5B is a partial top-view diagram of the sensing apparatus in the embodiment of FIG. 5A. Referring to FIGS. 5A and 5B, in the embodiment, the sensing apparatus 50 includes a plurality of pixel structures P, and the pixel structures P include at least one first sensing unit P1 and at least one second sensing unit P2, the first sensing unit P1 is for sensing the X-ray 99 with a first frequency range V1 and the second sensing unit P2 is for sensing the X-ray 99 with a second frequency range V2. The first sensing units P1 and the second sensing units P2 of the pixel structures P herein are alternately arranged in two dimensions. For example, the first sensing units P1 and the second sensing units P2 can be arranged like a Western checkerboard shown in FIG. 5B, which the disclosure is not limited to. In other embodiments, the first sensing units P1 and the second sensing units P2 can be more employed according to the sensing area size and the resolution demand in the practice. In short, by means of alternately arranging the first sensing units P1 and the second sensing units P2, the sensing apparatus 50 can sense different frequency ranges in the X-ray 99 in a single exposing by using different sensing units. In the embodiment, for example, the first sensing units P1 can sense the energy with a lower frequency range in the X-ray 99, while the second sensing units P2 can sense the energy with a higher frequency range in the X-ray 99. A complete image obtained by shooting with the X-ray 99 is like, for example, a whole Western checkerboard, the alternately arranged first sensing units P1 are like, for example, the white boxes in the Western checkerboard and the second sensing units P2 are like, for example, the black boxes in the Western checkerboard. Since the first sensing units P1 can sense a portion of the complete image, followed by quickly calculating out the image in the lower frequency range shot with the X-ray 99 through interpolation or other operation methods and the second sensing units P2 also similarly calculate out the image in the higher frequency range shot with the X-ray 99, so that the sensing apparatus 50 is able to quickly calculate out the image shot with the X-ray 99 in the higher frequency range and the image shot with the X-ray 99 in the lower frequency range through interpolating or other operations. The two images are performed by a successive image processing, such as by strengthening the image display of the bones or by eliminating the bone from the X-ray images to more clearly observe soft tissue, which helps medical diagnosis and can be applicable to other medical detections such as pleural detection (to eliminate the impact of ribs so as to more clearly observe the lungs), dental detection (to eliminate the impact of the teeth and jaw bone so as to more clearly observe oral soft tissue), bone mineral density, breast detection (to more clearly observe breast blood vessels, glands and lumps) and angiography. The sensing apparatus 50 can be also applicable to other non-biological materials, which the disclosure is not limited to.

Referring to FIGS. 5A and 5B, in more details, the sensing apparatus 50 further includes an electronic element layer N, and the pixel structure P include a sensing layer K, in which the first sensing unit P1 and the second sensing unit P2 are coupled to the electronic element layer N. The electronic element layer N receives a first electrical signal Q1 produced by the first sensing unit P1 in each of the pixel structures P corresponding to the X-ray 99 with the first frequency range V1 and receives a second electrical signal Q2 corresponding to the X-ray 99 with the second frequency range V1. The sensing layer K is disposed on the electronic element layer N and has at least one first sensing region K1 and at least one second sensing region K2. The first sensing region K1 forms at least a portion of the first sensing unit P1 and at least a portion of the second sensing unit P2. The sensing apparatus 50 further includes a plurality of reading lines RL disposed at the electronic element layer N. The reading lines RL are coupled to the first sensing units P1 and the second sensing units P2 to read the first electrical signals Q1 and the second electrical signals Q2. In other words, in the embodiment, when the X-ray 99 passes through the sensing layer K, it is sensed by the first sensing units P1 and the second sensing units, and then the electronic element layer N sends the first electrical signals Q1 and the second electrical signals Q2 to the reading lines RL. By splicing the first electrical signals Q1 and the second electrical signals Q2 respectively sensed by the pixel structures P, the image in the higher frequency range shot with the X-ray 99 and the image in the lower frequency range shot with the X-ray 99 can be quickly spliced out in a single exposing, which further can reduce the received radiation doses of the subject, meanwhile can also reduce ghost shadow or blur due to the moving or breathing of the subject during multi-shots so as to quickly obtain the X-ray 99 image in good quality and facilitate to aid clinical medical diagnosis. For example, in a cardiac catheterization procedure, the X-ray image serves for surgical aided guiding. However, the X-ray image of soft tissue has poor recognition, in order to clearly distinguish the situation of the small blood vessels and surrounding tissue to avoid scratching by the catheter or puncturing organization to cause massive internal bleeding, a contrast agent is injected into the vessel by the cardiac catheter to distinguish the vascular and the peripheral tissues, which, in some of the more complex surgical cases, is easier to cause burden on the patient's kidney even result in kidney failure and other diseases due to injecting the contrast agent too many times. By simultaneously shooting the X-ray images with two different frequency ranges, the sensing apparatus 50 can enhance the distinguishing capability for the different soft tissues therebetween and may further increase the identification of the X-ray image of soft tissue. Thereby, the embodiment can avoid the burden on the patient by excessive application of contrast agent due to the unclear image.

Continuing to FIGS. 5A and 5B, in the embodiment, the pixel structures P can further include a blocking layer F. The sensing layer K is disposed between the blocking layer F and the electronic element layer N. The material of the blocking layer F can refer to the material in the embodiment of FIG. 3, which is omitted to describe. The blocking layer F covers the second sensing regions K2 and masks the first frequency range V1 of the X-ray 99 to allow the ray of the second frequency range V2 penetrating through. The blocking layer F exposes the first sensing regions K1. In more details, the blocking layer F in the embodiment is not continuous; instead, the blocking layer F only covers the second sensing regions K2 over them and no blocking layer F is disposed over the first sensing regions K1. The sensing layer K in FIG. 5A can be a whole layer to sense the X-ray 99 with first frequency range V1 and second frequency range V2. In short, the sensing apparatus 50 can use the blocking layer F to screen out the first frequency range V1 with which the X-ray 99 is able to pass through so that the X-ray 99 with the first frequency range V1 can be received by the first sensing regions K1 and the X-ray 99 with the second frequency range V2 can be received by the second sensing regions K2. At the time, the first frequency range V1 and the second frequency range V2 may be partially overlapped with each other, so that the sensing apparatus 50 can simultaneously shoot images through the X-ray 99 with two different frequency ranges in a single exposing, which advances the image sharpness of the X-ray 99 and the image recognition. The pixel structures P in FIG. 5A can include a common electrode layer CE disposed between the blocking layer F and the sensing layer K for biasing the sensing layer K. In this embodiment, a diffusion layer may be deposited between the sensing layer K and the common electrode CE. However, in this embodiment, the schematic structure of this diffusion layer was omitted.

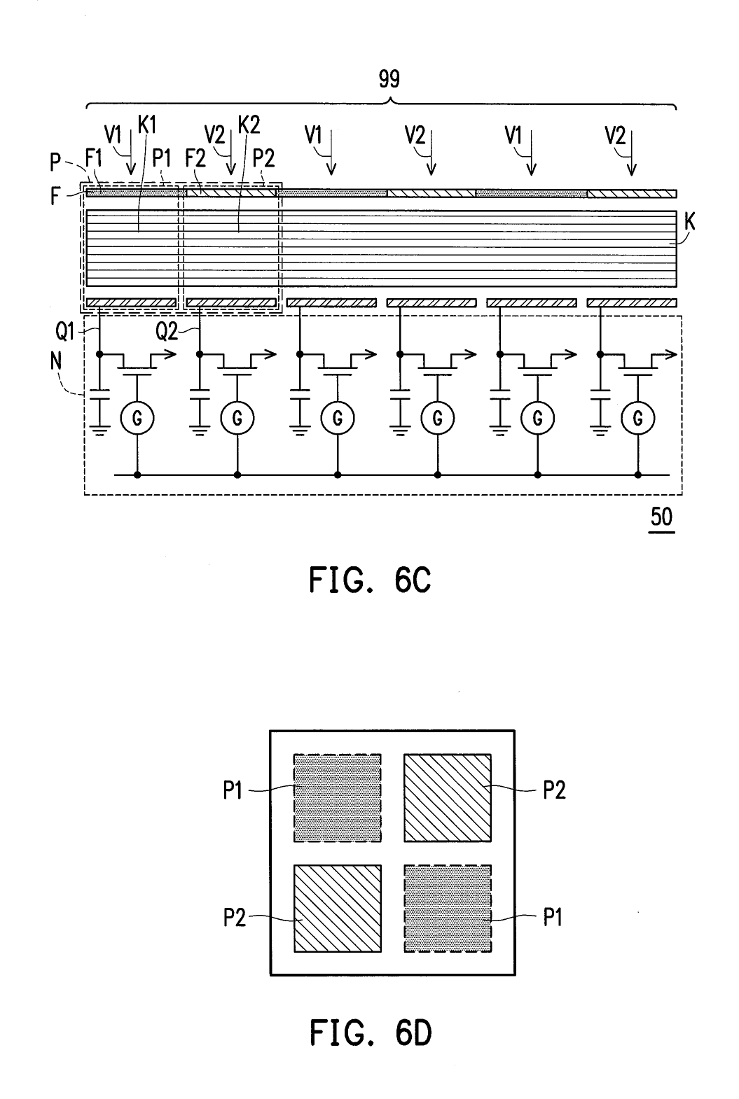

FIG. 6A is a diagram of the pixel apparatus in the embodiment of FIG. 5A after a first modification and FIG. 6B is a partial top-view diagram of the pixel apparatus in the embodiment of FIG. 6A. Referring to FIGS. 6A and 6B, in the embodiment, the blocking layer F further includes at least one first blocking area F1 and at least one second blocking area F2, in which the second blocking areas F2 cover every second sensing region K2 and mask the first frequency range V1 of the X-ray 99 to allow the X-ray 99 with the second frequency range V2 penetrating through, and the first blocking areas F1 cover every first sensing region K1 and mask the second frequency range V2 of the X-ray 99 to allow the X-ray 99 with the first frequency range V1 penetrating through. At the time, the first frequency range V1 and the second frequency range V2 are not overlapped with each other. In more details, the blocking layer F in the embodiment is continuous, and the first blocking areas F1 and the second blocking areas F2 are made of different materials and disposed over the first sensing regions K1 and the second sensing regions K2 so as to make the X-ray 99 with the different frequency ranges penetrate through. The pixel structures in FIGS. 6A and 6B have the similar effects to the pixel structures in FIGS. 5A and 5B, which is omitted to describe.

FIG. 6C is a diagram of the pixel apparatus in the embodiment of FIG. 5A after a second modification and FIG. 6D is a partial top-view diagram of the pixel apparatus in the embodiment of FIG. 6C. Referring to FIGS. 6A-6D, in this second modification, all are similar to FIG. 6A except that no common electrode layer CE is disposed in the embodiment. In addition to respectively make the X-ray 99 with the different frequency ranges penetrate through, the first blocking areas F1 and the second blocking areas F2 of the blocking layer F can provide the sensing layer K with a voltage. In other words, the blocking layer F in the embodiment has the same function of the alternately arranged blocking layers F shown in FIG. 6A. Meanwhile, the blocking layer F can provide the sensing layer K with a voltage to sense the X-ray 99. The first blocking areas F1 and the second blocking areas F2 herein are made of different materials (such as aluminium, copper, etc. in Table 1), which can further reduce the volume and simplify the structure of the sensing apparatus 50, but has the effect similar to the embodiment of FIG. 5A.

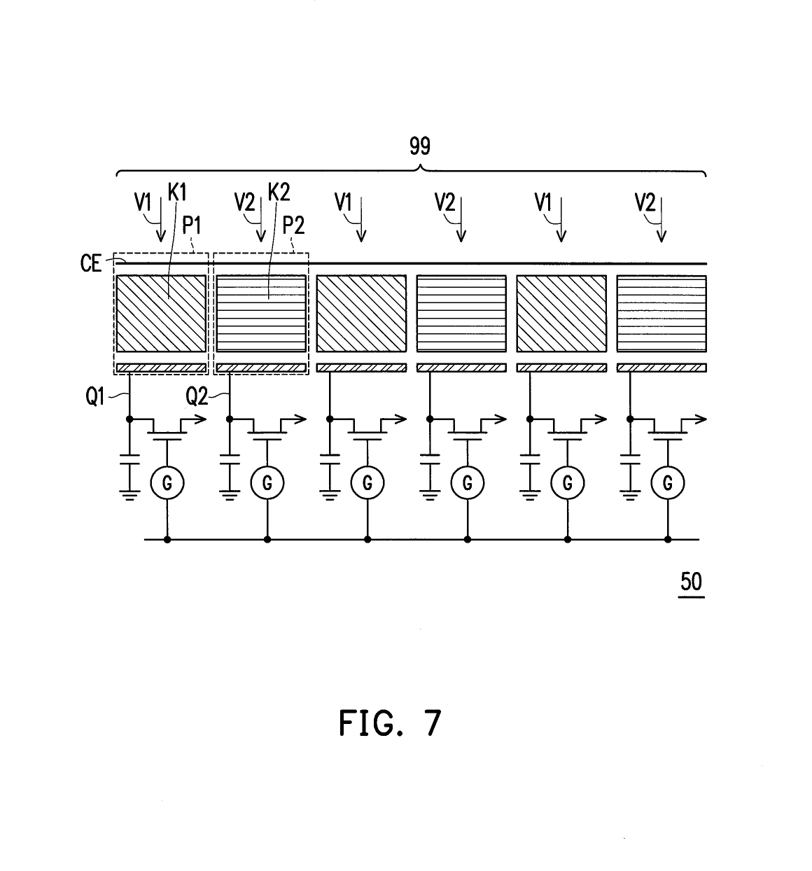

FIG. 7 is a diagram of the pixel apparatus in the embodiment of FIG. 5A after a third modification. Referring to FIG. 7, in the embodiment, no blocking layer F is employed. The first sensing region K1 and the second sensing region K2 can be made of different materials to receive the X-ray 99 with the different frequency ranges. The first sensing region K1 and the second sensing region K2 can be integrally formed or can be a plurality of alternately arranged sensing elements so as to have the similar functions of the first and second modifications, which is omitted to describe. However, in the embodiment, the common electrode layer CE is made of a same material used for applying high voltage only without filtering effect.

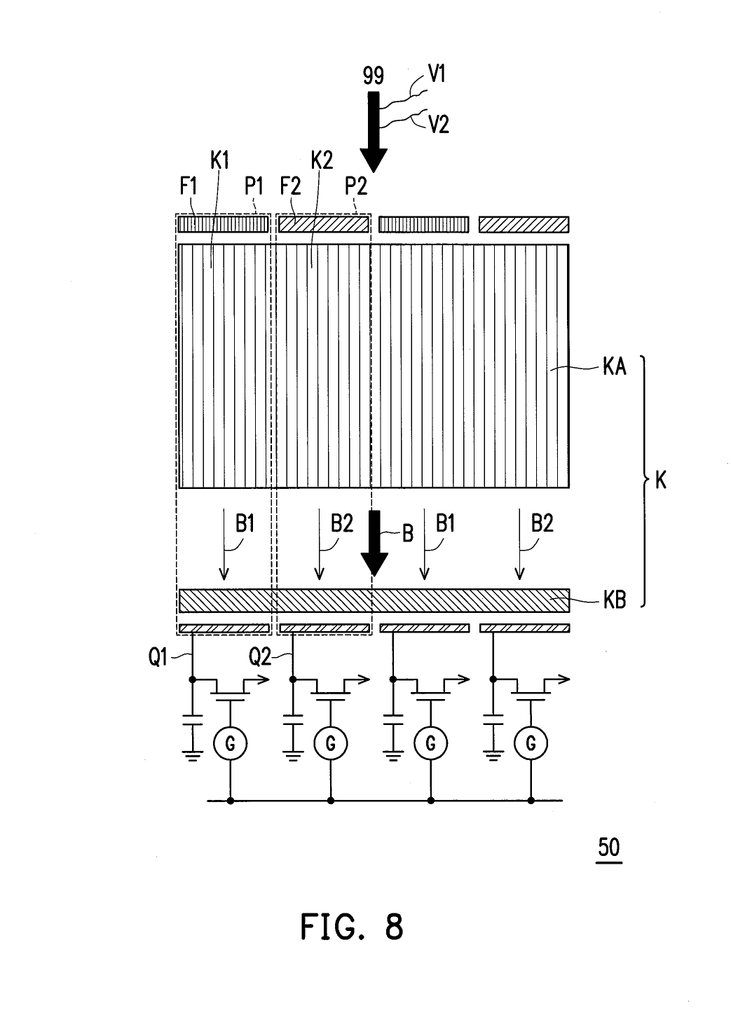

FIG. 8 is a diagram of the pixel apparatus in the embodiment of FIG. 5A after a fourth modification. Referring to FIG. 8, in this fourth modification, everything is similar to FIG. 6C except that the sensing layer K in the embodiment further includes a light conversion layer KA and a photosensitive layer KB. The light conversion layer KA converts the X-ray 99 into a visible light B. In more details, the light conversion layer KA respectively converts the X-ray 99 with the first frequency range V1 at the area corresponding to the first sensing units P1 and the X-ray 99 with the second frequency range V2 at the area corresponding to the second sensing units P2 into a first visible light B1 and a second visible light B2, while the photosensitive layer KB can sense the visible light B (i.e., the first visible light B1 and the second visible light B2). In general, the photosensitive layer KB is a pixel structure, and usually it is a hydrogenated amorphous silicon (a-Si: H) structure in order to receive visible light. The light conversion layer KA herein is, for example, a scintillator, and is able to change the shine band by means of doping technology. The light conversion layer KA can also add a reflective layer material with reflective effect in response to the shine energy of the X-ray at the border of the light conversion layer KA so as to increase the sensing efficiency. For example, if the material in Table 1 is used to plate the light conversion layer KA at the border thereof, the light conversion layer KA can also convert the X-ray into visible light during filtering the X-ray. In other words, in the first to third modifications of the sensing apparatus 50, the first sensing region Kl and the second sensing region K2 in the sensing layer K can convert the X-ray 99 into the first electrical signal Q1 and the second electrical signal Q2, but in the fourth modification of the embodiment, the light conversion layer KA in the sensing layer K converts the partial X-ray 99 into the visible light B first, and then, the photosensitive layer KB is used to receive the visible light B, and finally the first electrical signal Q1 and the second electrical signal Q2 corresponding to the intensity of the visible light B are provided. In the fourth modification of the embodiment, the second blocking areas F2 in the blocking layer F cover every second sensing region K2 and mask the first frequency range V1 of the X-ray 99 to make the X-ray 99 with the second frequency range V2 penetrate through; the first blocking areas F1 cover every first sensing region K1 and mask the second frequency range V2 of the X-ray 99 to make the X-ray 99 with the first frequency range V1 penetrate through. Then, the light conversion layer KA senses the X-ray 99 with the first frequency range V1 and produces a first visible light B1 corresponding to the first frequency range V1; the light conversion layer KA senses the X-ray 99 with the second frequency range V2 and produces a second visible light B2 corresponding to the second frequency range V2. The photosensitive layer KB senses the first visible light B1 to produce the first electrical signal Q1; the photosensitive layer KB senses the second visible light B2 to produce the second electrical signal Q2. At the time, the first frequency range V1 and the second frequency range V2 are not overlapped with each other. In this way, the fourth modification of the embodiment has the similar effect to the first and third modifications of the sensing apparatus 50, which is omitted to describe. In other embodiments, the blocking layer F can also cover the second sensing regions K2 and mask the first frequency range V1 of the X-ray 99 to allow the X-ray 99 with the second frequency range V2 penetrating through. The blocking layer F exposes the first sensing regions K1, and at the time, the first frequency range V1 and the second frequency range V2 can be partially overlapped with each other, which is the same as the first modification of the sensing apparatus 50 and is omitted to describe. The photosensitive layer KB can be photodiode TFT, charge coupled device (CCD) or complementary metal oxide semiconductor sensor (CMOS sensor).

It should be noted that the embodiments of FIGS. 6A, 6C and 8 can adopt the alternately arranged structures of the blocking layer F or adopt a single blocking layer F with carving-hollow to make a Western checkerboard structure as FIG. 5A, where the adjacent pixels has no blocking layer F and the energies of the X-ray 99 received by the adjacent pixels have different bands to enable the signal processing of the image and performing dual-energy operation or multi-energy operation.

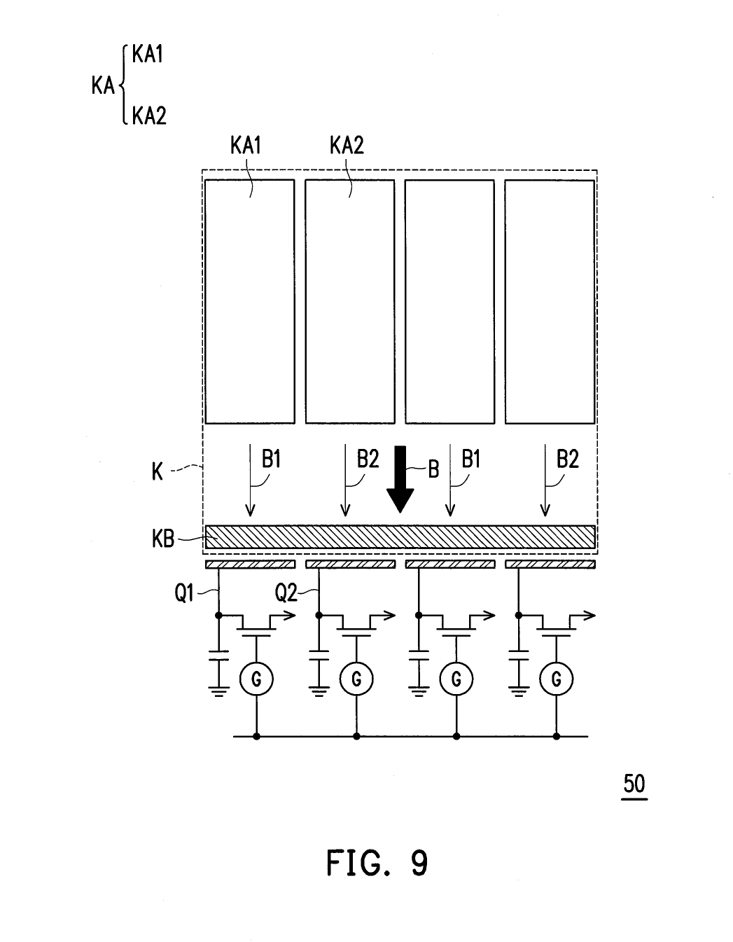

FIG. 9 is a diagram of the pixel apparatus in the embodiment of FIG. 5A after a fifth modification. Referring to FIG. 9, the fifth modification is similar to the modification of FIG. 7 except that in the embodiment, the sensing layer K can further include a light conversion layer KA and a photosensitive layer KB. The light conversion layer KA includes at least one first light conversion unit KA1 corresponding to the first sensing region K1 and at least one second light conversion unit KA2 corresponding to the second sensing region K2. For example, the first light conversion units KA1 and the second light conversion units KA2 can be integrally formed or a plurality of alternately arranged light conversion . The first light conversion unit KA1 and the second light conversion unit KA2 have different materials such as cadmium telluride (CdTe), thallium-doped cesium iodide (CsI(Tl)), gadolinium oxide sulfide (Gd₂O₂S), europium-doped barium or europium (II)-doped barium fluorobromide (BaFBr:Eu). The first light conversion unit KA1 can sense the first frequency range V1 of the X-ray 99 and produce the first visible light B1; the second light conversion unit KA2 can sense the second frequency range V2 of the X-ray 99 and produce the second visible light B2. In this way, the fifth modification of the sensing apparatus 50 has the similar effect to the first to fourth modifications, which is omitted to describe.

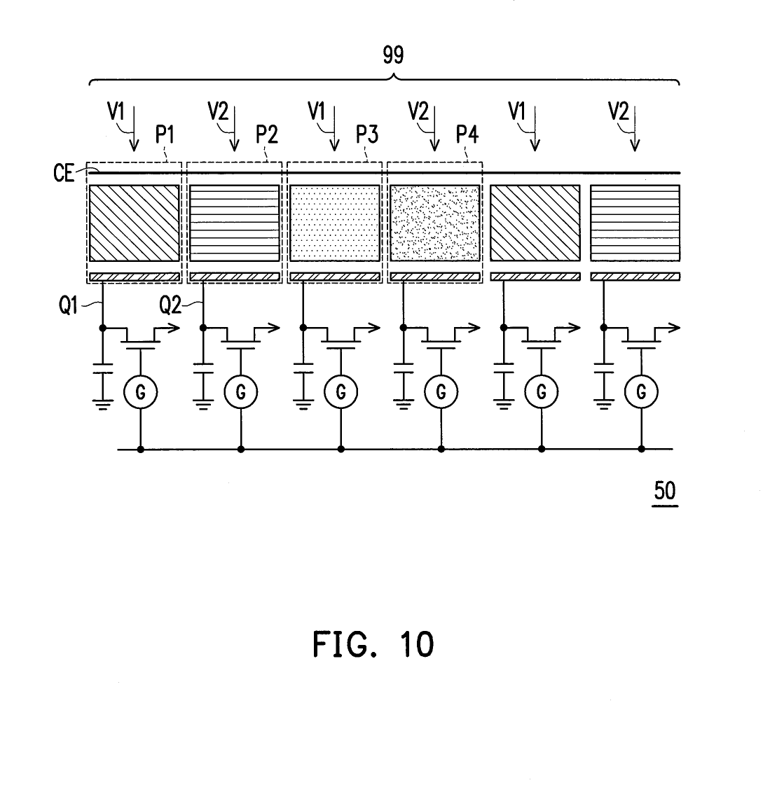

FIG. 10 is a diagram of the pixel apparatus in the embodiment of FIG. 5A after a sixth modification. Referring to FIG. 10, the sixth modification is similar to the modification of FIG. 7 except that in the embodiment, the pixel structures includes at least three sensing units, that is a first sensing unit P1, a second sensing unit P2 and a third sensing unit P3 for example. More specifically, every pixel structure includes at least three sensing units. The at least three sensing units are used to respectively receive the X-ray 99 with the different frequency ranges and they are alternately arranged. For example, in the modification of FIG. 10, the three sensing units include, for example, a first sensing unit P1, a second sensing unit P2, a third sensing unit P3 and a fourth sensing unit P4, in which the first sensing unit P1 can sense the X-ray 99 with a first frequency range V1, the second sensing unit P2 can sense the X-ray 99 with a second frequency range V2, the third sensing unit P3 can sense the X-ray 99 with a third frequency range V3 and a fourth sensing unit P4 can sense the X-ray 99 with the fourth frequency range V4. The first sensing unit P1 until the fourth sensing unit P4 in FIG. 10 are a sensing regions array formed by arranging a plurality of different sensitive materials as shown in FIG. 7A, which the disclosure is not limited to. In other modifications, similar to FIG. 5A or 6A, different blocking materials are used to dive a same sensing layer into different sensing areas so as to sense X-ray 99 with more frequency ranges, which facilitates the successive image processing for dividing and composing multiple closer portions to enhance the effect of the aided medical diagnosis. The arrangements and the sequence of the various sensing units are limited to the modification of the embodiment as an example, which the disclosure is not limited to.

In summary, the sensing apparatus in the embodiments of the disclosure can sense different frequency ranges in an X-ray 99. Thereby, the sensing apparatus can quickly obtain images with the X-ray 99 with the different frequency ranges. According to that the attenuation extents of the ray of the different frequency ranges on bones and different soft issues are different, a successive image processing is used to enhance the bone image or the images of the different soft issues so as to further advance the sharpness and recognition of the image, increase the shooting efficiency and image quality, and meanwhile reduce the radiation dose received by the subjects during shooting and help the medical diagnosis.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A pixel structure of sensing apparatus comprising:
a first scan line;
a second scan line;
a reading line;
a first sensing unit, coupled between the first scan line and a bias and coupled between the reading line and the bias, wherein the first sensing unit is for sensing a first energy of the X-ray with a first frequency range, and the first sensing unit outputs a first reading signal corresponding to the first energy to the reading line in response to a first scan signal on the first scan line; and
a second sensing unit, coupled between the second scan line and the bias and between the reading line and the bias, wherein the second sensing unit is for sensing a second energy of the X-ray with a second frequency range, and the second sensing unit outputs a second reading signal corresponding to the second energy to the reading line in response to a second scan signal on the second scan line, wherein the first scan signal and the second scan signal respectively enable the first sensing unit and the second sensing unit.

2. The pixel structure as claimed in claim 1, further comprises a blocking layer disposed between the first sensing unit and the second sensing unit, wherein the blocking layer masks a portion of the X-ray with frequencies falling in the first frequency range but out of the second frequency range and enables another portion of the X-ray with the second frequency range penetrating through, wherein the X-ray sequentially passes through the first sensing unit, the blocking layer and the second sensing unit.

3. The pixel structure as claimed in claim 2, wherein the material of the blocking layer is aluminium, copper, tin, zinc, lead, samarium, cerium, gadolinium, erbium, rhodium, a compound or a mixture.

4. The pixel structure as claimed in claim 1, wherein the first sensing unit comprises:
a first sensing element, used for sensing the first energy and converting the sensed first energy into a first electrical signal;
a first storage element, coupled to the first scan line and the first sensing element for storing the first electrical signal;
a first amplifying element, coupled to the first storage element, the first scan line and the reading line, wherein the first amplifying element outputs the first reading signal corresponding to the first electrical signal to the reading line in response to the first scan signal come from the first scan line; and
a first resetting element, coupled to the first storage element and the first scan line, wherein the first resetting element is for resetting the first storage element in response to a first resetting signal.

5. The pixel structure as claimed in claim 4, wherein a current input terminal of the first amplifying element is coupled to the first scan line and a terminal of the first storage element, a control terminal of the first amplifying element is coupled to the other terminal of the first storage element, and a current output terminal of the first amplifying element is coupled to the reading line.

6. The pixel structure as claimed in claim 5, wherein a first terminal of the first resetting element is coupled to the first scan line, a control terminal of the first resetting element receives the first resetting signal, and a second terminal of the first resetting element is coupled to the control terminal of the first amplifying element.

7. The pixel structure as claimed in claim 4, wherein the second sensing unit comprises:
a second sensing element, used for sensing the first energy and converting the sensed second energy into a second electrical signal;
a second storage element, coupled to the second scan line and the second sensing element for storing the second electrical signal;
a second amplifying element, coupled to the second storage element, the second scan line, and the reading line, wherein the second amplifying element outputs the second reading signal corresponding to the second electrical signal to the reading line in response to the second scan signal come from the second scan line; and
a second resetting element, coupled to the second storage element and the second scan line, wherein the second resetting element is for resetting the second storage element in response to a second resetting signal.

8. The pixel structure as claimed in claim 7, wherein a current input terminal of the second amplifying element is coupled to the second scan line and a terminal of the second storage element, a control terminal of the second amplifying element is coupled to the other terminal of the second storage element and a current output terminal of the second amplifying element is coupled to the reading line.

9. The pixel structure as claimed in claim 8, wherein a second terminal of the second resetting element is coupled to the second scan line, a control terminal of the second resetting element receives the second resetting signal, and a second terminal of the second resetting element is coupled to the control terminal of the second amplifying element.

10. The pixel structure as claimed in claim 1, wherein the first frequency range and the second frequency range are substantially not overlapped with each other.

11. The pixel structure as claimed in claim 1, wherein the first frequency range and the second frequency range are partially overlapped with each other.

12. A sensing apparatus, comprising:
a first photoelectric conversion layer, used for converting a first energy portion of an X-ray into a first electrical signal;
a second photoelectric conversion layer, used for converting a second energy portion of the X-ray into a second electrical signal;
a blocking layer, disposed between the first photoelectric conversion layer and the second photoelectric conversion layer to filter out partial ray with a portion of frequency range of the X-ray from the X-ray;
a first electronic element layer, disposed between the first photoelectric conversion layer and the blocking layer to enable the first photoelectric conversion layer and receive the first electrical signal; and
a second electronic element layer, disposed between the second photoelectric conversion layer and the blocking layer to enable the second photoelectric conversion layer and receive the second electrical signal.

13. The sensing apparatus as claimed in claim 12, further comprising:
a first common electrode layer, disposed on the first photoelectric conversion layer, wherein the first photoelectric conversion layer is disposed between the first electronic element layer and the first common electrode layer; and
a second common electrode layer, disposed on the second photoelectric conversion layer, wherein the second photoelectric conversion layer is disposed between the second electronic element layer and the second common electrode layer, and the first common electrode layer and the second common electrode layer are together coupled to a same bias.

14. The sensing apparatus as claimed in claim 13, wherein the first electronic element layer has a plurality of first pixel units, the first pixel units comprise at least one first transistor, a first pixel electrode, and a first storage capacitor coupled to each other, the second electronic element layer has a plurality of second pixel units, the second pixel units comprise at least one second transistor, a second pixel electrode and a second storage capacitor coupled to each other.

15. The sensing apparatus as claimed in claim 12, wherein frequency range of the first energy part and frequency range of the second energy part are substantially not overlapped with each other.

16. The sensing apparatus as claimed in claim 12, wherein the frequency range of the first energy part and the frequency range of the second energy part are substantially partially overlapped with each other.

17. The sensing apparatus as claimed in claim 12, wherein material of the blocking layer is aluminium, copper, tin, zinc, lead, samarium, cerium, gadolinium, erbium, rhodium, a compound or a mixture.

18. A sensing apparatus, comprising:
a plurality of pixel structures, wherein the pixel structures comprise at least one first pixel unit and at least one second pixel unit, the first pixel unit is for sensing X-ray with a first frequency range and the second pixel unit is for sensing X-ray with a second frequency range; and
an electronic element layer, wherein the first pixel unit and the second pixel unit are coupled to the electronic element layer, and the electronic element layer receives a first electrical signal produced by the first sensing unit in every pixel structure corresponding to the X-ray with the first frequency range and receives a second electrical signal produced by the second sensing unit corresponding to the X-ray with the second frequency range;
wherein the first sensing units and the second sensing units of the pixel structures are alternately arranged in two dimensions.

19. The sensing apparatus as claimed in claim 18, further comprising a plurality of reading lines disposed at the electronic element layer, wherein the reading lines are coupled to the first sensing unit and the second sensing unit and read the first electrical signals and the second electrical signals.

20. The sensing apparatus as claimed in claim 18, wherein the pixel structure further comprises a sensing layer disposed on the electronic element layer, the sensing layer has at least one first sensing region and at least one second sensing region, wherein the first sensing region forms at least one portion of the first sensing unit and the second sensing region forms at least one portion of the second sensing unit.

21. The sensing apparatus as claimed in claim 20, wherein the pixel structure further comprises a blocking layer, the sensing layer is disposed between the blocking layer and the electronic element layer, wherein the blocking layer covers the second sensing regions and masks the first frequency range of the X-ray to make the X-ray in the second frequency range penetrate through, and the blocking layer exposes the first sensing regions.

22. The sensing apparatus as claimed in claim 21, further comprising a common electrode layer disposed between the blocking layer and the sensing layer to apply a bias to the sensing layer.

23. The sensing apparatus as claimed in claim 20, wherein the pixel structure further comprises a blocking layer, the sensing layer is disposed between the blocking layer and the electronic element layer, wherein the blocking layer comprises at least one first blocking area and at least one second blocking area, the second blocking areas cover every the second sensing area and mask the first frequency range of the X-ray to make the X-ray in the second frequency range penetrate through, and the first blocking areas cover every the first sensing region and mask the second frequency range of the X-ray to make the X-ray in the first frequency range penetrate through.

24. The sensing apparatus as claimed in claim 23, further comprising a common electrode layer disposed between the blocking layer and the sensing layer to apply a bias to the sensing layer.

25. The sensing apparatus as claimed in claim 20, wherein the sensing layer further comprises a light conversion layer and a photosensitive layer, the light conversion layer converts the X-ray into a visible light, the light conversion layer respectively converts the X-ray with the first frequency range and the X-ray with the second frequency range into a first visible light and a second visible light at areas respectively corresponding to the first sensing unit and the second sensing unit, and the sensing layer senses the visible light.

26. The sensing apparatus as claimed in claim 25, wherein the light conversion layer comprises at least one first light conversion unit corresponding to the first sensing region and at least one second light conversion unit corresponding to the second sensing region.

27. The sensing apparatus as claimed in claim 18, wherein the pixel structures comprises at least three sensing units, the at least three sensing units comprise the first sensing unit, the second sensing unit and a third sensing unit, the at least three sensing units are used to respectively receive the X-ray with a different frequency range, and the at least three sensing units are in staggered arrangement.
